(19) United States
(12) Patent Application Publication
(10) Pub. No.: US 2022/0051340 A1
(43) Pub. Date: Feb. 17, 2022

(54) System and Method Using Crowd-Sourced Data to Evaluate Driver Performance

(71) Applicant: GM GLOBAL TECHNOLOGY OPERATIONS LLC, Detroit, MI (US)

(72) Inventors: Andrew P. ROSE, Glen Allen, VA (US); Donald K. GRIMM, Utica, MI (US); Fan BAI, Ann Arbor, MI (US)

(21) Appl. No.: 16/994,045

(22) Filed: Aug. 14, 2020

(51) Int. Cl. G06Q 40/08; G06F 16/9536; G07C 5/08; G07C 5/00; G06Q 50/26; G06Q 30/02

(52) U.S. Cl. CPC G06Q 40/08; G06F 16/9536; G06Q 30/0201; G07C 5/008; G06Q 50/265; G07C 5/0808

(57) ABSTRACT

A driver monitoring system configured to monitor the performance of a driver of a first vehicle system communicating wirelessly with the driver monitoring system. The system comprises a vehicle database comprising a vehicle records associated with a plurality of vehicle systems and a vehicle server comprising a driver behavior module that receives from the first vehicle system first event data captured by a plurality of sensors. The first event data includes a first event time and a first event location. The server identifies a first driver behavior associated with the first event data. The server uses the first event time and the first event location to identify in the vehicle database a plurality of neighboring vehicles proximate the first vehicle system and determines from vehicle records an average value associated with the first driver behavior.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The driving performance of a particular driver may be of value to an employer of the driver, particularly if the driver operates a vehicle owned by the employer. Driver performance is useful, for example, in warning or punishing a reckless driver, in setting insurance rates, and in evaluating insurability. These actions may rely on recorded driving history and aggregated class statistics.

Conventional driver monitoring systems generate data by monitoring the onboard diagnostics (OBD) port, which provides only limited information. For example, the OBD port may monitor only driving speed, which may be correlated with local speed limits to determine speeding habits of a particular driver. Present systems may not have access to other useful data from the vehicle, such as collision warning data.

### SUMMARY

It is one aspect of the disclosure to provide a driver monitoring system configured to monitor the performance of a driver of a first vehicle system that is communicating wirelessly with the driver monitoring system. The driver monitoring system comprises a vehicle database comprising a plurality of vehicle records associated with a plurality of vehicle systems and a vehicle server comprising a driver behavior module configured to receive from the first vehicle system first event data captured by a plurality of sensors in the first vehicle system. The first event data includes a first event time and a first event location. The server identifies a first driver behavior associated with the first event data. The vehicle server is further configured to use the first event time and the first event location to identify in the vehicle database a plurality of neighboring vehicles proximate the first vehicle system and to determine from vehicle records associated with the plurality of neighboring vehicles an average value associated with the first driver behavior.

In one embodiment, the driver monitoring system is configured to compare the first driver behavior to a threshold value and, in response to the comparison, to transmit to the driver a warning message.

In another embodiment, the driver monitoring system transmits the warning message if the driver is a client of an insurance provider.

In still another embodiment, the threshold value is a speed limit associated with a roadway determined by the first event location.

In yet another embodiment, the driver monitoring system is configured to determine if the first driver behavior exceeds the average value by more than a threshold value.

In a further embodiment, the driver monitoring system, in response to a determination that the first driver behavior exceeds the average value by more than the threshold value, transmits to the driver a warning message.

In a still further embodiment, the driver monitoring system transmits the warning message if the driver is a client of an insurance provider.

In a yet further embodiment, the vehicle server further comprises a behavior characterization module configured to receive from the driver behavior module the first driver behavior and to characterize the first driver behavior into at least one of a plurality of behavior categories and a risk assessment module configured to analyze the at least one characterized driver behavior in the plurality of behavior categories and to determine therefrom a driver profile that may include a risk assessment for the driver of the vehicle system.

In an embodiment, the driver monitoring system, in response to a determination that the first driver behavior exceeds the threshold value, increases an insurance premium associated with the driver.

In another embodiment, the driver monitoring system, in response to a determination that first driver behavior exceeds the threshold value, transmits to an owner of the vehicle system a message informing the owner that the driver has exceeded the threshold value.

It is another aspect of the disclosure to provide a method of monitoring the performance of a driver of a first vehicle system communicating wirelessly with a driver monitoring system. The method comprises: i) storing in a vehicle database a plurality of vehicle records associated with a plurality of vehicle systems; ii) in a vehicle server of the driver monitoring system, receiving from the first vehicle system first event data captured by a plurality of sensors in the first vehicle system, the first event data including a first event time and a first event location; iii) identifying a first driver behavior associated with the first event data; iv) using the first event time and the first event location to identify in the vehicle database a plurality of neighboring vehicles proximate the first vehicle system; and v) determining from the vehicle records associated with the plurality of neighboring vehicles an average value associated with the first driver behavior.

In one embodiment, the method further comprises comparing the first driver behavior to a threshold value and, in response to the comparison, transmitting to the driver a warning message.

In another embodiment, the warning message is transmitted if the driver is a client of an insurance provider.

In still another embodiment, the threshold value is a speed limit associated with a roadway determined by the first event location.

In yet another embodiment, the method further comprises determining if the first driver behavior exceeds the average value by more than a threshold value.

In a further embodiment, the method further comprises, in response to a determination that the first driver behavior exceeds the average value by more than the threshold value, transmitting to the driver a warning message.

In a still further embodiment, the warning message is transmitted if the driver is a client of an insurance provider.

In a yet further embodiment, the method further comprises: i) characterizing the first driver behavior into at least one of a plurality of behavior categories; and ii) analyzing the at least one characterized driver behavior in the plurality of behavior categories and determining therefrom a driver profile that may include a risk assessment for the driver of the vehicle system.

In one embodiment, the method further comprises, in response to a determination that the first driver behavior exceeds the threshold value, increasing an insurance premium associated with the driver.

In another embodiment, the method further comprises, in response to a determination that first driver behavior exceeds the threshold value, transmitting to an owner of the vehicle system a message informing the owner that the driver has exceeded the threshold value.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an overview of a driver monitoring system according to an embodiment of the present disclosure.

FIG. 2 is a functional block diagram of an exemplary vehicle system that includes a driver monitoring system according to the principles of the present disclosure.

FIG. 3 illustrates the flow of sensor information from the vehicle system to the vehicle communication server according to the principles of the present disclosure.

FIG. 4 is a flow diagram illustrating sensor data processing operations in the vehicle system according to the principles of the present disclosure.

FIG. 5 is a flow diagram illustrating driver alert operations in the vehicle system according to the principles of the present disclosure.

FIG. 6 is a flow diagram illustrating the evaluation of driver performance in the server according to the principles of the present disclosure.

FIG. 7A and 7B are a flow diagram illustrating the evaluation of driver performance in a vehicle communication server using crowd-sourced data from a plurality of vehicle systems according to the principles of the present disclosure.

In the drawings, reference numbers may be reused to identify similar and/or identical elements.

### DETAILED DESCRIPTION

Advanced onboard diagnostics and communication systems (e.g., OnStar by GM) enable a vehicle manufacturer to provide a driver monitoring system that executes algorithms that are useful for evaluating driver performance, setting insurance rates, and evaluating insurability of a driver based on a greater number of parameters than are available through the OBD port.

The present disclosure describes a system for monitoring one or more driver habits, such as following distance (or tailgating), lane changes, sudden accelerations, sudden deceleration, swerving, and the like. The disclosed system monitors information from a plurality of vehicle sensors to assess the tailgating habits of a driver. The driver monitoring system uses telematics to report the monitored information to a central office (e.g., employer, insurance company, etc.) for subsequent use in, for example, reprimanding or disciplining the driver or setting insurance rates.

Advantageously, the unique disclosed system uses vehicle sensors to identify tailgating habits, speeding habits, lane changing habits of a driver and uses that habit data for evaluating driver performance and for insurance purposes. The disclosed system may do one or more of the following operations:

a) Monitor and report the number of collision warning alerts that are generated by the collision warning system;

b) Monitor variables provided by the collision warning system to identify the following distance (tailgating) habits of a driver;

c) Periodically transfer following distance data to a server for analysis and processing;

d) In response to a following distance metric falling below a threshold, the server may send a warning to the driver that insurance rates may increase.

e) In response to the following distance metric remaining below the threshold for more than a predetermined time, the server may initiate an increase in insurance premiums for the driver;

f) The following distance metrics may include: average predicted time to stop, average following distance, and/or combined factor of vehicle speed, following distance, and predicted time to stop;

g) For drivers currently not insured, when the following distance metric is below a threshold for a predetermined period, the server may offer an insurance product to the driver;

h) Collect camera/sensor data for time before and after a collision warning activation, send the data to the server, and alert vehicle owner of collision warning activation.

i) The data may be retrieved by the vehicle owner to review or replay the incident (i.e., Game Film mode);

j) Directly contact the driver (Direct Communication mode) via the telematics system without providing any option to answer or disconnect. For example, the server alerts the owner to risky driving behavior and connect the owner of the vehicle operator through the telematics system. The driver cannot ignore this as the voice of the owner plays on the speakers of the vehicle. This action may be performed only when the vehicle is traveling is a safe context (i.e., at vehicle ignition, when the vehicle is moving in a steady state, in non-congested environment, not backing up, etc.)

In an advantageous embodiment, the present disclosure describes a system for monitoring driver habits, based on crowd-sourced data from two or more vehicles within a predefined distance of each other. The driver monitoring system is configured to receive vehicle data from a plurality of vehicles and to calculate indicators related to driver performance metrics and communicate this information to one or more persons that may be associated with the received vehicle data.

By way of example, the disclosed driver monitoring system may gather crowd-sourced data from multiple vehicles to determine average vehicle speed and other driving behavior. The driver monitoring system monitors information received from a vehicle computing system to assess the speed of two or more vehicles within a predefined distance. This information may be reported to an owner of a vehicle or to an insurance provider for setting insurance rates.

The driver monitoring system may perform one or more of the following processes: i) receive vehicle speed data from two or more vehicles within a predefined distance; ii) compare the speed data from two or more vehicles to a predefined threshold value; iii) report to an owner or insurance provider if at least one vehicle exceeds the threshold value; and iv) execute a vehicle algorithm that periodically transfers specific vehicle data to a server for analysis and processing.

In response to a first vehicle speed or a speed limit for a segment of the road on which the first vehicle is traveling and crowd-sourced data from nearby vehicles, the server may determine if the first vehicle is within an acceptable driving behavior parameter threshold and send a warning to the driver that insurance rates may increase. In response to the driving behavior parameter threshold, the server may initiate an increase in insurance premiums for the driver.

The driver monitoring system evaluates driver performance using crowd-source vehicle data from other vehicles proximate to the first vehicle. Each vehicle sends location, time, vehicle speed, and speed limit information to a server. The server may aggregate data from those vehicles in the same location to obtain statistics for that road segment. This allows the server to evaluate a driver based on the driving pattern present at the location at that time. The server may evaluate the driver relative to the other vehicles traveling at the location at the same time and computer a driver behavior metric based on the crowd-sourced data. The server may modify the driver behavior metric if the driver is operating the vehicle significantly different from other drivers at that location. The driver behavior metric may be useful for indicating whether the driver is driving faster or slower than nearby vehicles or moving similarly to surrounding vehicles.

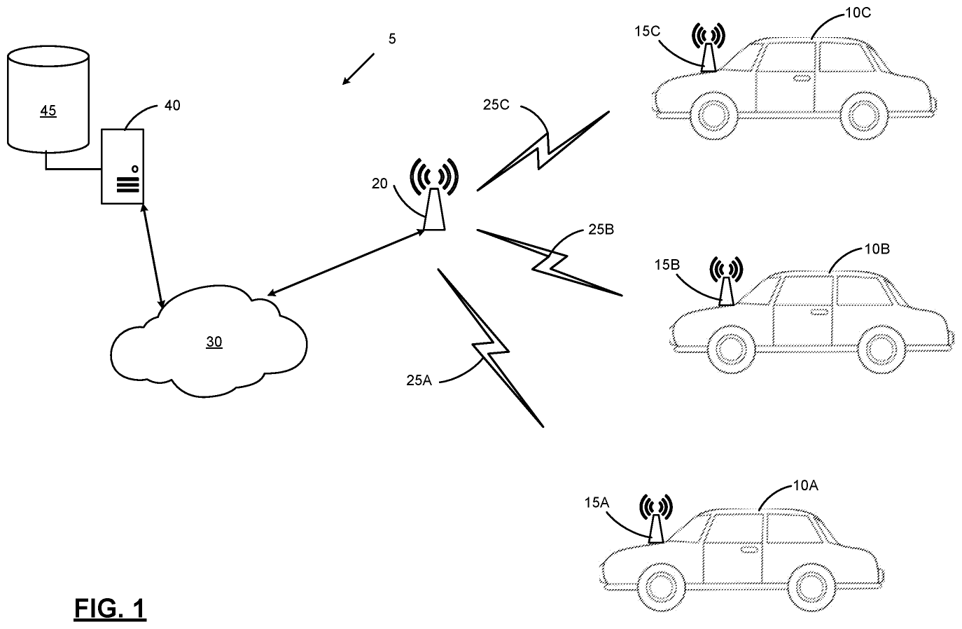

FIG. 1 is an overview of a driver monitoring system 5 for disabling vehicle functions according to an embodiment of the present disclosure. The driver monitoring system 5 comprises a plurality of vehicle system 10A, 10B and 10C, a vehicle communication server (VCS) 40, and a vehicle back-office database (DB) 45. Each of the vehicle system 10A-10C includes a wireless access point (AP) 15A, 15B, and 15C that enables the vehicle system 10A-10C to communicate with the VCS 40 via an IP network 30 (e.g., the Internet) and a wireless access point 20. In a typical scenario, the wireless access point 20 is a base station of a cellular network and the wireless access point 15 in the vehicle system 10 is a cellular mobile transceiver.

According to the principles of the present disclosure, the vehicle communication server (VCS) 40 may transmit to the vehicle systems 10A-10C via wireless communication links 25A-25C, respectively, instructions that use authentication and integrity protocols securely to retrieve selected vehicle data from a plurality of vehicle sensors. For example, the VCS 40 may transmit to the AP 15A via wireless communication link 25A a digitally signed, cryptographic token to enable a control module in the vehicle system 10A to gather sensor data and upload the sensor data to VCS 40 via wireless communication link 25A.

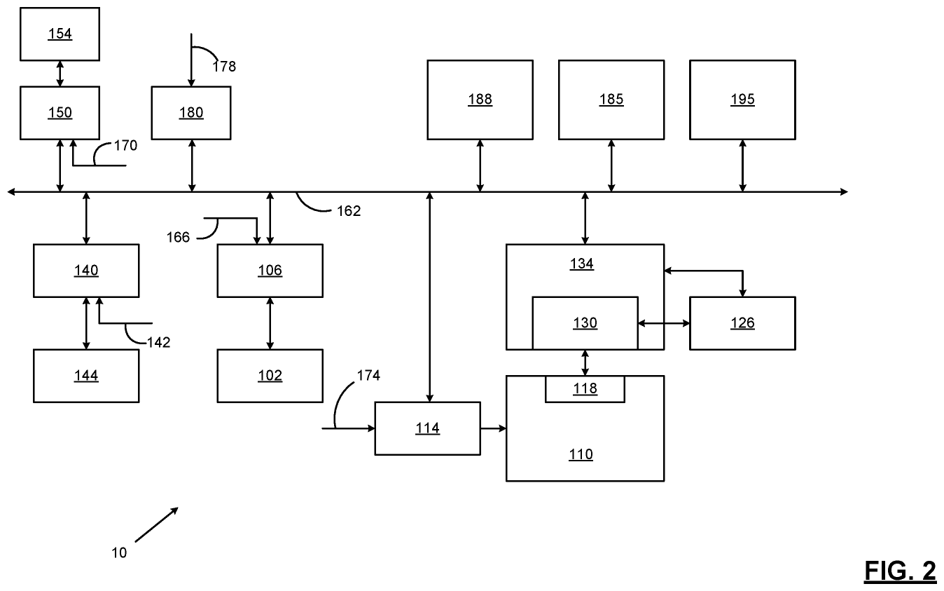

FIG. 2 is a functional block diagram of an exemplary vehicle system 10 (i.e., any one of the vehicle systems 10A-10C) that includes a driver monitoring system according to the principles of the present disclosure. While the present disclosure shows and describes a vehicle system 10 for a hybrid vehicle, the present disclosure is also applicable to non-hybrid vehicles incorporating only an internal combustion engine. While the present disclosure uses a vehicle as an exemplary embodiment, the present disclosure is also applicable to non-automobile implementations, such as boats and aircraft.

An engine 102 combusts an air/fuel mixture to generate drive torque. An engine control module (ECM) 106 controls the engine 102 based on one or more driver inputs. For example, the ECM 106 may control actuation of engine actuators, such as an electronically controlled throttle valve, one or more spark plugs, one or more fuel injectors, valve actuators, camshaft phasers, an exhaust gas recirculation (EGR) valve, one or more intake air-flow boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system 10 may include one or more electric motors. For example, an electric motor 118 may be implemented within the transmission 110 as shown in the example of FIG. 1A. An electric motor can act either as a generator or as a motor at a given time. When acting as a generator, an electric motor converts mechanical energy into electrical energy. The electrical energy may charge a battery 126 via a power control device (PCD) 130. When acting as a motor, an electric motor generates torque that supplements or replaces torque output by the engine 102. While the example of one electric motor is provided, the vehicle may include zero or more than one electric motor.

A power inverter control module (PIM) 134 may control the electric motor 118 and the PCD 130. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as a power inverter module (PIM) in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 based on the position of the steering wheel. As an example, the steering control module 140 may control vehicle steering via an EPS motor 144 based on the SWA 142. However, the vehicle may include another type of steering system. An electronic brake control module (EBCM) 150 may selectively control brakes 154 of the vehicle.

Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166 which may be provided to the ECM 106. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

According to an exemplary embodiment of the present disclosure, the vehicle system 10 further comprises an advanced computing module 185, a sensors module 188, a map module 190, and a wireless transceiver (XCVR) module 195. In FIG. 2, the wireless transceiver module 195 corresponds to the wireless access points 15A-15C in FIG. 1. The sensors module 188 may include a plurality of sensors that support, for example, basic cruise control, full speed range adaptive cruise control, and/or semi-autonomous or true autonomous driving. These sensors may include, but are not limited to, an on-board GPS receiver, a plurality of radar detectors and a plurality of cameras that detect objects (e.g., other vehicles) proximate the vehicle system 10, a light detection and ranging (LiDAR) system, a wheel speed sensors, a steering wheel angle (SWA) sensor, a plurality of accelerometers, and the like.

The sensors in sensors module 188 may be used to detect numerous driver events. The radar detectors and cameras, for example, may determine following distance (i.e., potential tailgating). The cameras may detect lane markers and determine whether and how often the vehicle system 10 changes lanes, drifts across the center of the road into oncoming traffic, drifts onto the shoulder of the road, lane centering performance and the like. The accelerometers may detect sudden accelerations, sudden decelerations (i.e., braking), and sudden or exaggerated lateral movements, indicating swerving or sharp turns.

In vehicle system 10, an embedded microprocessor that executes program instructions in an associated embedded memory controls the operations of each of the electronic vehicle subsystems. Hereafter, the microprocessor and memory in each subsystem may be referred to generically as an electronic control unit (ECU) module. The steering control module 140, the engine control module 106, the sensors module 188, and the electronic brake control module 150 are all examples of vehicle subsystems. A dedicated embedded ECU module controls each one of these vehicle subsystems.

The advanced computing module 185 comprises a high performance computing platform that controls many of the higher order functions and lower order functions of the vehicle system 10. In a typical implementation, the advanced computing module 185 may be implemented as a microprocessor and an associated memory. Like the ECU modules in the vehicle subsystems, the advanced computing module 185 also executes a kernel program that controls the overall operation of the advanced computing module 185.

According to the principles of the present disclosure, the advanced computing module 185 consumes information from the sensors module 188 (e.g., wheel speed data, steering wheel angle sensor data, brake status data, LiDAR system data, radar data, camera images, GPS data, accelerometer data, etc.) to determine the speed, direction, and location of the vehicle system 10. The advanced computing module 185 uses the consumed information to send commands to, for example, the steering control module 140, the engine control module 106, and the electronic brake control module 150, to control the speed, braking, and/or direction of the vehicle system 10. The advanced computing module 185 is also responsible for communicating with the VCS 40 and uploading vehicle sensor data requested by the VCS 40 in order to monitor and evaluate driver performance.

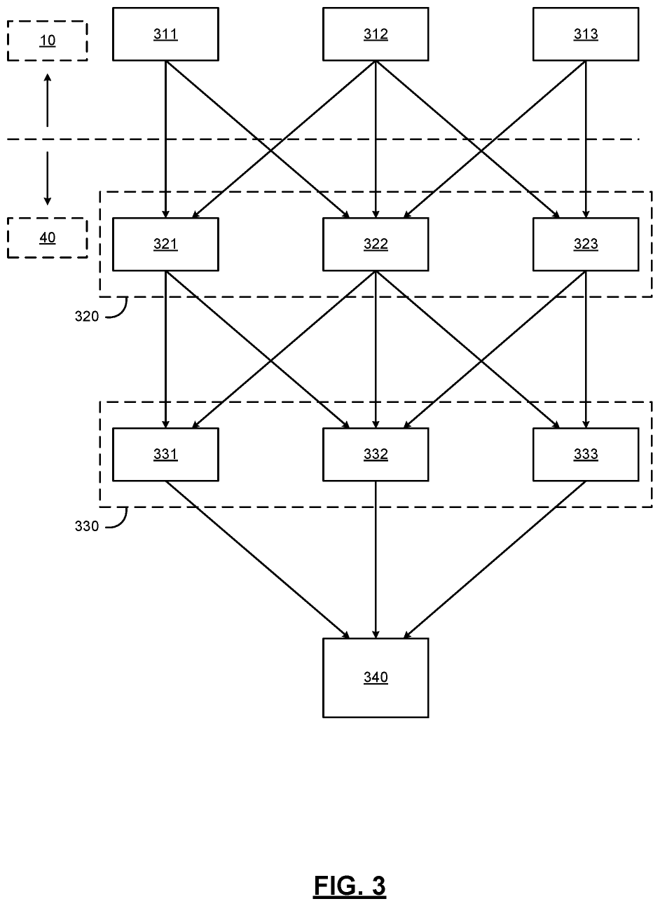

FIG. 3 illustrates the flow of sensor information from the vehicle system 10 to the vehicle communication server (VCS) 40 according to the principles of the present disclosure. In the vehicle system 10, the advanced computing module 185 may poll a plurality of sensors for sensor data that is useful for evaluating the performance of the driver. For example, vehicle sensor 311 may be one or more accelerometers, vehicle sensor 312 may be a wheel speed sensor, and vehicle sensor 313 may be a vehicle camera. The advanced computing module 185 then uploads the polled sensor data to the VCS 40.

The VCS 40 comprises a plurality of data processing modules, including a driver behavior module 320, a behavior characterization module 330, and a risk assessment module 340. The driver behavior module 320 of the VCS 40 receives the captured sensor data and may identify one or more driver behaviors 321-323. By way of example, the driver behavior module 320 may analyze the sensor data to identify driver behavior 321, which includes, for example, sharp turns, sudden braking, and/or sudden acceleration. The driver behavior module 320 also may analyze the sensor data to identify driver behavior 322, which includes, for example, low speed driving, high speed driving, and speed profiles. Finally, the driver behavior module 320 may analyze the sensor data to identify driver behavior 323, which includes, for example, tailgating, lane changes, drifting across lane markers, drifting onto the shoulder, and the like.

The behavior characterization module 330 of the VCS 40 may then analyze the identified driver behaviors 321-323 to characterize the identified driver behaviors 321-323 into categories associated with the driver, including a microscopic behavior category 331, a macroscopic behavior category 332, and a historical behavior record category 333 associated with the driver. The microscopic behavior category 331 may include speeding, reckless driving, distracted driving, and the like. The macroscopic behavior category 332 may include temporal, spatial, and spatio-temporal hot zones. These may include periods during which a driver engages in more dangerous driving and/or roads where the driver engages in more dangerous driving. The historical behavior record category 333 classifies the driver behaviors according to patterns, occurrences, frequencies, and the like.

The driving behaviors listed above are merely exemplary and should not be construed to limit the scope of the disclosure or the claims below. Driving behaviors may also include a speed profile with respect to surrounding traffic, a lane change profile, a lane following behavior (maintain consistent distance with respect to lane markers), unsignaled lane changes, and lane changes on curves. Other driving behaviors may include a safety alert activations that are captured whether systems are enabled or not, such as forward collision alerts, front or rear cross traffic alerts, lane keeping alerts, lateral collision alerts, and park assist alerts. Driving behaviors may further include near-miss detections, the number of anti-lock braking system events relative to others in the same temporal and/or spatial region, and the number of traction and/or stability control system events relative to others in the same temporal and/or spatial region. Driving behaviors may also include distraction due to infotainment system usage, the number of red light violation events, the number of traffic sign violation events, the number of road rule violation events (e.g., no turn on red, no U-turn), the number of wrong-way driving events, unsafe driving in parking lots (e.g., across aisles), and the failure to yield to pedestrians. In vehicle systems equipped with monitoring systems that capture driver gaze data, the driving behaviors may include extended off-road looks, detection of driver drowsiness, distractedness, intoxication, or strong emotions, failure to look at traffic signals, failure to look at oncoming traffic before turning, and failure to look in both directions before crossing. Driver behavior may also include detection of smartphone use (including talking or texting), eating, smoking, fighting, singing, and the like, as well as interior cabin distractions that are detected from in-cabin cameras and microphones (e.g., children, pets).

The risk assessment module 340 of the VCS 40 may use the microscopic behavior category 331, the macroscopic behavior category 332, and the historical behavior record category 333 to determine a driver profile that may include a risk assessment for the driver of the vehicle system 10. The risk assessment module 340 may use an open-ended regression model for evaluating insurance risk. For example, the VC risk assessment module 340 may characterize each of the selected risk-exposing behaviors using an RFS principle in which: i) a Recency value (V_{R}) indicates how recently a driver exhibited a particular behavior; ii) a Frequency value (V_{F}) indicates how often a driver exhibits this behavior feature; and iii) a Severity value (V_{M}) indicates how severe the behavior is.

The risk assessment module 340 may quantify an implicit occurring rate of this feature (fₘ) for the driver as:

r(fₘ, driver)=w_{R}V_{R}+w_{F}V_{F}+w_{M}V_{M},

where the sum of the weighting factors (w_{R}, w_{F}, w_{M}) equals 1.

The risk assessment module 340 may build a logistic regression model to link the insurance risk with these risk-exposing features:

The VCS 40 may be configured to monitor the sensor data to make insurance decisions. For example, the VCS 40 may identify that the driver has a low-risk driving style (e.g., large average following distance, infrequent lane changes). The VCS 40 may automatically generate and send an insurance quote to the driver. The quote may include a favorable rate due to low-risk driving style.

If the VCS 40 identifies the driving style as being more risky, the VCS 40 may not generate a quote. Further, if the driver is currently an insurance customer, the VCS 40 may issue a warning to the driver that insurance rates may be increased unless driving habits change. The VCS 40 may use the sensor information to generate a driver rating and transmit the driver rating to the driver to provide feedback to encourage cautious driving. The VCS 40 may present the driver rating information in an application on a mobile device used by the driver.

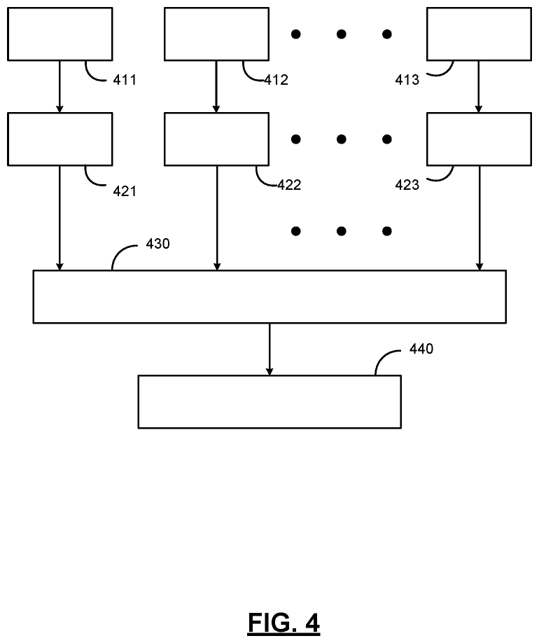

FIG. 4 is a flow diagram illustrating sensor data processing operations in the vehicle system 10 according to the principles of the present disclosure. In the vehicle system 10, the individual sensors in the sensors module 188 continually detect N events in real time. By way of example, in 411, an accelerometer may detect a sudden deceleration or acceleration (Event 1 Detection). In 412, a radar or camera may detect an object proximate the front of the vehicle system 10 as it moves (Event 2 Detection). In 413, a camera may detect a lane marker coming closer to the vehicle system 10 (Event N Detection).

Next, either the sensor or the advanced computing module 185 may characterize the detected event. For example, in 421, the advanced computing module 185 may characterize the detected Event 1 as sudden braking. In 422, the advanced computing module 185 may characterize the detected Event 2 as tailgating. In 423, the advanced computing module 185 may characterize the detected Event N as crossing the center lane divider (i.e., drifting into oncoming traffic lanes). In 430, the advanced computing module 185 collects all of the event data and, in 440, sends the event data to VCS 40.

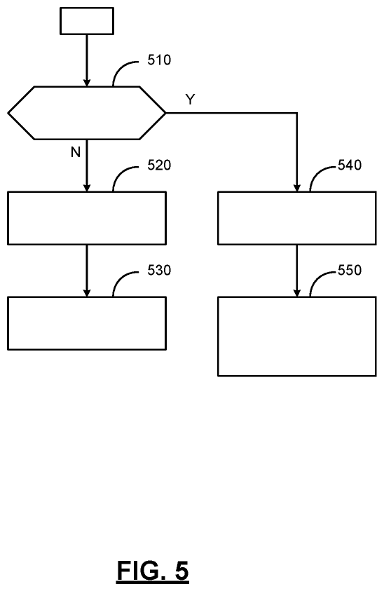

FIG. 5 is a flow diagram illustrating driver alert operations in the vehicle system 10 according to the principles of the present disclosure. FIG. 5 illustrates the operation of the advanced computing module 185 when Call-in mode is supported. In uninterruptible Call-in Mode, the vehicle owner may contact the driver directly. In 510, the advanced computing module 185 determines whether Call-In mode is enabled. If NO in 510, then in 520, the advanced computing module 185 receives message from VCS 40 via the telematics system (e.g., via wireless transceiver module 195). In 530, the advanced computing module 185 displays the receive message on a dashboard screen.

If YES in 510, then in 540, the advanced computing module 185 selects a pre-synthesized announcement corresponding to the event that was detected. In 550, the advanced computing module 185 plays the pre-synthesized announcement through the vehicle speakers. The driver does not have the option to answer or to disconnect. The owner's voice may be played through speakers automatically. Thus, if the vehicle owner is alerted to risky driving behavior and contacts the vehicle operator directly through the telematics system, the driver cannot ignore the owner.

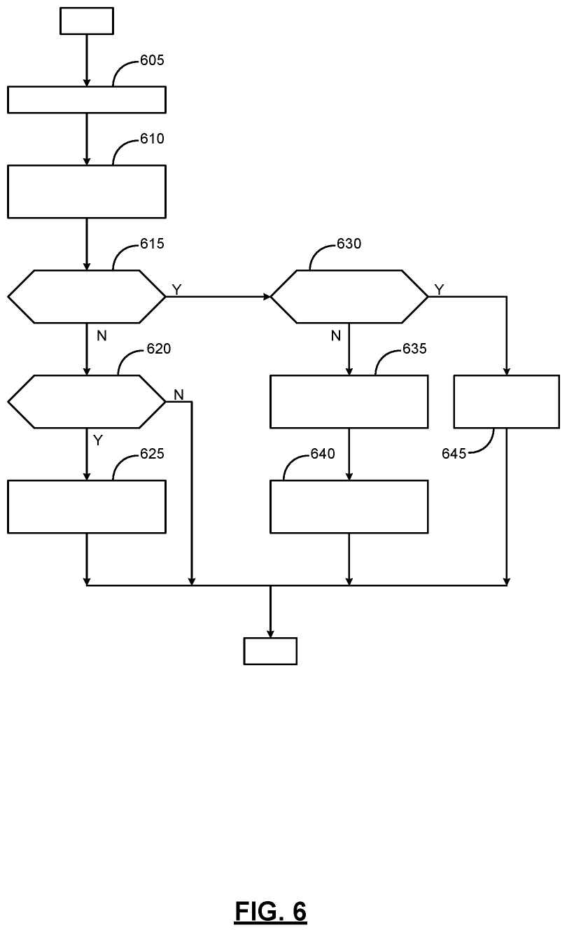

FIG. 6 is a flow diagram illustrating the evaluation of driver performance in the vehicle communication server (VCS) 40 according to the principles of the present disclosure. In 605, the VCS 40 receives sensor data from the vehicle system 10. In 610, the VCS 40 evaluates the driver performance and generates driver metrics as described above in FIGS. 3 and 4. In 615, the VCS 40 determines if the selected driver is a current client of the insurance company that is evaluating the driver performance. If NO in 615, then in 620, the VCS 40 determines if a selected driver metric is less than a threshold value. For example, the VCS 40 may determine if the number of tailgating events in a designated period (e.g., day, week, month) is below a threshold value. If NO in 620, the process ends. If YES in 620, the VCS 40 may generate an insurance offer at a preferred rate and transmit the offer to the driver and the process ends.

If YES in 615, then in 630, the VCS 40 determines if the selected driver metric is less than a threshold value. If YES in 630, then in 645, the VCS 40 may give a reward or incentive to the driver for being a good driver. In NO in 630, the in 635, the VCS 40 may send a warning message to inform the driver that the driver has had too many events (e.g., too many tailgating incidents) in the defined period. In 640, the VCS 40 may also increase the insurance premium of the driver.

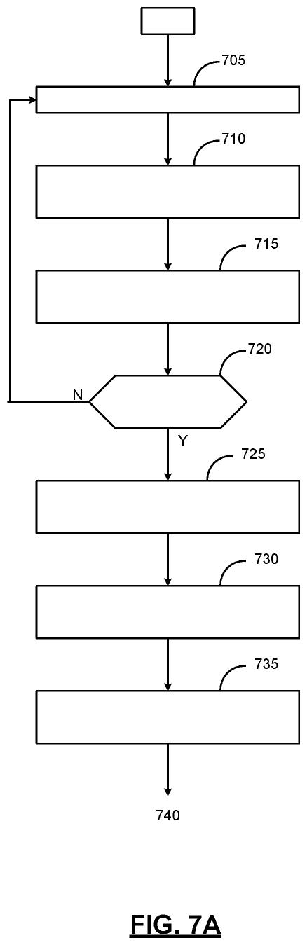

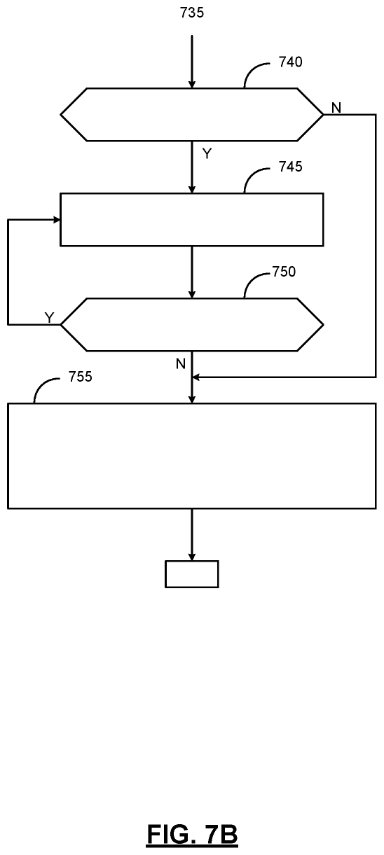

FIGS. 7A and 7B are a flow diagram illustrating the evaluation of driver performance in the vehicle communication server (VCS) 40 using crowd-sourced data from a plurality of vehicle systems 10 according to the principles of the present disclosure. Much of the foregoing discussion focuses on monitoring the driver performance of a selected driver using sensor data from the same vehicle system that the selected driver operates. However, these principles are readily adapted to monitoring the performance of the selected driver using crowd-sourced data from nearby vehicles that are driving on the same roads as the selected driver and at approximately the same time. In this way, the VCS 40 may compare the performance of the selected driver to the average performance of the other drivers to detect particular driver behaviors. These driver behaviors may include driving significantly faster or slower than nearby vehicles, changing lanes (or drifting across lane markers) significantly more often than nearby vehicles, braking suddenly significantly more often than nearby vehicles, and the like.

In FIGS. 7A and 7B, the flow diagram describes the VCS 40 monitoring driver performance based on crowd-sourced vehicle speed. However, those skilled in the art will understand that this is by way of example only and should not be construed to limit the scope of the disclosure. In alternative embodiments, the VCS 40 may readily be adapted to monitor driver performance based on other crowd-sourced data (e.g., lane changes, sudden braking).

In 705, the VCS 40 receives vehicle data from Vehicle A (e.g., vehicle system 10A). In 710, the VCS 40 determines the speed and location of Vehicle A based on the received vehicle data. The vehicle data also includes a time stamp indicating when the sensors in the Vehicle A measured the speed and location data. In 715, the VSC 40 retrieves from the vehicle DB 45 the applicable speed limit information based on Vehicle A location.

In 720, the VCS 40 determines if the speed of Vehicle A exceeds the applicable speed limit. If NO in 720, then the VCS 40 returns to 705 and continues to monitor vehicle data from Vehicle A. If YES in 720, then the VCS 40 in 725 may identify in the DB 45 selected crowd-sourced data of other vehicle systems 10 corresponding to the same location and time window as Vehicle A. In 730, the VCS 40 receives the vehicle data for the identified vehicle systems. In 735, the VCS 40 uses the received crowd-sourced data to determine a crowd-sourced vehicle speed (e.g., average speed) based on the vehicle data from identified vehicles.

In 740, the VCS 40 determines if the Vehicle A speed is greater than the crowd-sourced speed by more than a predetermined threshold value. If YES in 740, then in 745, the VCS 40 may send a warning to the driver of Vehicle A that insurance rates may increase. In 750, the VCS 40 may determine if the speed of Vehicle A is within an acceptable driver behavior threshold value, even if the Vehicle A speed is greater than the crowd-sourced speed by more than the threshold value. If YES in 750, then the VCS 40 may return to 745 and simply issue a warning. If NO in 750 or if NO in 740, the VCS 40 may initiate an increase or decrease in insurance premiums for the driver of Vehicle A.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A driver monitoring system configured to monitor the performance of a driver of a first vehicle system that is communicating wirelessly with the driver monitoring system, the driver monitoring system comprising:
a vehicle database comprising a plurality of vehicle records associated with a plurality of vehicle systems; and
a vehicle server comprising a driver behavior module configured to receive from the first vehicle system first event data captured by a plurality of sensors in the first vehicle system, the first event data including a first event time and a first event location, and to identify a first driver behavior associated with the first event data,
wherein the vehicle server is further configured to use the first event time and the first event location to identify in the vehicle database a plurality of neighboring vehicles proximate the first vehicle system and to determine from vehicle records associated with the plurality of neighboring vehicles an average value associated with the first driver behavior.

2. The driver monitoring system of claim 1, wherein the driver monitoring system is configured to compare the first driver behavior to a threshold value and, in response to the comparison, to transmit to the driver a warning message.

3. The driver monitoring system of claim 2, wherein the driver monitoring system transmits the warning message if the driver is a client of an insurance provider.

4. The driver monitoring system of claim 2, wherein the threshold value is a speed limit associated with a roadway determined by the first event location.

5. The driver monitoring system of claim 1, wherein the driver monitoring system is configured to determine if the first driver behavior exceeds the average value by more than a threshold value.

6. The driver monitoring system of claim 5, wherein the driver monitoring system, in response to a determination that the first driver behavior exceeds the average value by more than the threshold value, transmits to the driver a warning message.

7. The driver monitoring system of claim 6, wherein the driver monitoring system transmits the warning message if the driver is a client of an insurance provider.

8. The driver monitoring system of claim 6, the vehicle server further comprises:
a behavior characterization module configured to receive from the driver behavior module the first driver behavior and to characterize the first driver behavior into at least one of a plurality of behavior categories; and
a risk assessment module configured to analyze the at least one characterized driver behavior in the plurality of behavior categories and to determine therefrom a driver profile that may include a risk assessment for the driver of the vehicle system.

9. The driver monitoring system of claim 8, wherein the driver monitoring system, in response to a determination that the first driver behavior exceeds the threshold value, increases an insurance premium associated with the driver.

10. The driver monitoring system of claim 8, wherein the driver monitoring system, in response to a determination that first driver behavior exceeds the threshold value, transmits to an owner of the vehicle system a message informing the owner that the driver has exceeded the threshold value.

11. A method of monitoring the performance of a driver of a first vehicle system communicating wirelessly with a driver monitoring system, the method comprising:
storing in a vehicle database a plurality of vehicle records associated with a plurality of vehicle systems;
in a vehicle server of the driver monitoring system, receiving from the first vehicle system first event data captured by a plurality of sensors in the first vehicle system, the first event data including a first event time and a first event location;
identifying a first driver behavior associated with the first event data;
using the first event time and the first event location to identify in the vehicle database a plurality of neighboring vehicles proximate the first vehicle system; and
determining from the vehicle records associated with the plurality of neighboring vehicles an average value associated with the first driver behavior.

12. The method of claim 11, further comprising comparing the first driver behavior to a threshold value and, in response to the comparison, transmitting to the driver a warning message.

13. The method of claim 12, wherein the warning message is transmitted if the driver is a client of an insurance provider.

14. The method of claim 12, wherein the threshold value is a speed limit associated with a roadway determined by the first event location.

15. The method of claim 10, further comprising determining if the first driver behavior exceeds the average value by more than a threshold value.

16. The method of claim 15, further comprising, in response to a determination that the first driver behavior exceeds the average value by more than the threshold value, transmitting to the driver a warning message.

17. The method of claim 16, wherein the warning message is transmitted if the driver is a client of an insurance provider.

18. The method system of claim 16, further comprising:
characterizing the first driver behavior into at least one of a plurality of behavior categories; and
analyzing the at least one characterized driver behavior in the plurality of behavior categories and determining therefrom a driver profile that may include a risk assessment for the driver of the vehicle system.

19. The method of claim 18, further comprising, in response to a determination that the first driver behavior exceeds the threshold value, increasing an insurance premium associated with the driver.

20. The method of claim 18, further comprising in response to a determination that first driver behavior exceeds the threshold value, transmitting to an owner of the vehicle system a message informing the owner that the driver has exceeded the threshold value.
